(19) United States
(12) Patent Application Publication
(10) Pub. No.: US 2010/0270517 A1
(43) Pub. Date: Oct. 28, 2010

(54) SOLID DOPANTS FOR CONDUCTIVE POLYMERS, METHOD AND APPARATUS FOR PREPARING THE SAME USING PLASMA TREATMENT, AND SOLID DOPING METHOD OF CONDUCTIVE POLYMERS

(75) Inventors: Yong Cheol Hong, Gyeonggi-do (KR); Suck Hyun Lee, Gyeonggi-do (KR); O. Pil Kwon, Gyeonggi-do (KR); Tae Ja Kim, Gyeonggi-do (KR)

Correspondence Address: TUROCY & WATSON, LLP, 127 Public Square, 57th Floor, Key Tower, CLEVELAND, OH, 44114, US

(73) Assignees: ELPANI CO., LTD., Gyeonggi-do (KR); AJOU UNIVERSITY INDUSTRY-ACADEMIC COOPERATION FOUNDATION, Gyeonggi-do (KR)

(21) Appl. No.: 12/766,379

(22) Filed: Apr. 23, 2010

(30) Foreign Application Priority Data
Apr. 24, 2009 (KR) 10-2009-0035928

(51) Int. Cl. H01B 1/12; C01G 23/047; C01G 41/02; C01G 31/02; C01G 53/04; C01G 11/00; C01B 19/04; C01G 23/00; C01G 9/06; C01G 9/04; C01F 11/20; C01G 19/04; C01G 9/02; C01G 9/08; C01G 11/02; C01G 41/00; C01B 33/00; C01F 17/00; B01J 19/08; B01J 19/10

(52) U.S. Cl. 252/519.33; 423/610; 423/606; 423/594.17; 423/594.19; 423/594.18; 423/509; 423/608; 423/544; 423/491; 423/497; 423/494; 423/622; 423/566.1; 423/511; 423/594.13; 423/326; 423/263; 422/186; 422/128; 977/773; 977/932

(57) ABSTRACT

The present disclosure provides a solid dopant for doping a conductive polymer, which has a high dispersibility in a solvent by a plasma treatment, a method and an apparatus for preparing the solid dopants, a solid doping method of a conductive polymer using the solid dopants, and a solid doping method of a conductive polymer using plasma.

### CROSS-REFERENCE TO RELATED APPLICATION

This application claims the benefit of Korean Patent Application 10-2009-0035928, filed on Apr. 24, 2009, the entire disclosures of which are incorporated herein by reference.

### FIELD OF THE INVENTION

The present disclosure relates to solid dopants for conductive polymers which carry electricity, a method and an apparatus for preparing the solid dopants, a doping method of conductive polymers using the solid dopants, and a solid doping method of conductive polymers. To be specific, the present disclosure relates to solid dopant containing nanoparticles capable of doping a conjugated conductive polymer, which is a semiconductor, of high dispersibility and no conductivity in a solvent with conductive polymer salts, a method and an apparatus for preparing the solid dopant using a plasma treatment, a doping method of a conductive polymer using the solid dopant, and a solid doping method of conductive polymers using a plasma treatment.

### BACKGROUND OF THE INVENTION

Conductive polymers became known to the public by American professors A. J. Heeger and A. G. MacDiamid and Japanese professor H. Shirakawa when they were awarded the Novel Prize in chemistry in 2000. They first reported in 1977 that polyacetylene as a (conductive) polymer can carry electricity through a doping treatment. After that, lots of research has been done in this regard

There have been known polyaniline, polypyrrole, polythiophene, poly phenylene-vinylene, poly phenylene sulfide, poly para-phenylene as main conductive polymers. Depending on conductivity, these conductive polymers have been used as antistatic materials (10⁻¹³-10⁻⁷ S/cm) and static discharge materials (10⁻⁶-10⁻² S/cm). A conductive polymer having conductivity of about 1 S/cm or more has been used as an electromagnetic shielding material, a battery electrode, a semiconductor, a solar cell or the like.

Of the above-described main conductive polymers, polyaniline has received the most attention due to its stability in air and high applicability in industries and it can be classified into completely reduced leucoemeraldine, partially reduced emeraldine, and completely oxidized pernigraniline according to its oxidation state.

Basically, if a polymer having conductivity is oxidized, reduced or doped with an acid or a base, polaron is formed and electrons are moved so as to carry electricity. Particularly, among the conductive polymers, if a base form (emeraldine, EB) of polyaniline is doped with organic acid or inorganic acid, it becomes a conductive polymer salt (emeraldine salt, ES). The organic acid or inorganic acid serving as a dopant may be hydrochloric acid, bromic acid, sulfuric acid, pyruvic acid, phosphoric acid, dichloroacetic acid, acrylic acid, citric acid, formic acid, methanesulfonic acid, benzensulfonic acid, p-toluenesulfonic acid, phorsulfonic acid, dodecylbenzenzsulfonic acid, dinonylnaphthalenesulfonic acid, polystyrenesulfonic acid, polyacrylic acid, heteropolyanion, C₁-C₂₄ alkyl, oxidized C₁-C₂₄ alkyl 4-sulfophthalic acid diester, 4-sulfo-1,2-benzenecarboxylic acid C₁-C₂₄ alkyl ester, bis(2-ethylhexyl) hydrogen phosphate or 2-acrylamido-2-methyl-1-propanesulfonic acid.

However, the above-described organic or inorganic acid used as a dopant in a doping treatment to a conductive polymer is volatile, and, thus, it cannot provide environmental stability to the conductive polymer.

Further, it has been widely known that the conductive polymers are not easily dissolved. However, if the conductive polymers are miniaturized into nano-sized particles and dispersed with a binder, high conductivity can be achieved. Here, a nanoparticle has a greatly increased specific surface area as compared to the existing material. Such an increased specific surface area of the nanoparticle causes a different surface effect from a surface effect of the existing material. As a size of a particle is decreased, the number of molecules at a surface is relatively increased. For example, when a size of a particle is about 5 nm, about 50% of molecules constituting the particle are positioned at a surface, and when a size of the particle is about 2 nm, a ratio of the molecules reaches about 90%. Since a ratio of the molecules at the surface is relatively high, the nanoparticle has a high ratio of surface energy to bond energy as compared to the existing material. As a size of a particle is decreased from about 20 nm to about 1 nm, a ratio of surface energy to bond energy becomes increased from about 5% to about 30%. Atoms constituting the nanoparticle are in an energetically stable state in which a balance between an attractive force and a repulsive force is maintained by an interaction between adjacent atoms, but atoms positioned at its surface is in a high energy state since there exists only an attractive force caused by internal atoms. Due to the above-described surface effect, the nanoparticle has a surface active characteristic which can be seen in a catalyst or a surface reaction of a catalyst.

Furthermore, it is difficult to effectively carry out a doping treatment to a composite containing a conductive polymeric dispersant due to a large surface area and a surface effect. Particularly, there is an urgent need for a technique for doping conductive nanoparticles existing on a thin film.

### BRIEF SUMMARY OF THE INVENTION

The present inventors have studied to solve the above-described problems of conventional techniques. Particularly, Lee, one of the present inventors, has prepared a conductive polymer, as a conductive polymer of pure metallicity, having conductivity about three to five times higher than any conventional conductive polymer with a high purity and disclosed in “Nature, vol. 441, pp. 65 (2006).” The present inventors studied the above-stated conductive polymer by performing various experiments using nanoparticles as a dopant instead of organic or inorganic acid. As a result of the study, the present inventors have found that it is possible to prepare a conductive polymer in a nonvolatile and stable manner by treating a conductive polymer with various plasma gases or by doping a conductive polymer using dopant nanoparticles in any shape treated with plasma to form a functional group on a surface thereof.

Accordingly, the present disclosure provides a solid doping method of a conductive polymer using a formation of a functional group on a nanoparticle by irradiating plasma thereon, and an apparatus for performing such a method.

However, the problem to be solved by the present disclosure is not limited to the above description and other problems can be appreciated by those skilled in the art from the following descriptions.

In view of the foregoing, the present disclosure provides solid dopants for doping a conductive polymer, which have a high dispersibility in a solvent by a plasma treatment, a method and an apparatus for preparing the solid dopants, a solid doping method of a conductive polymer using the solid dopants, and a solid doping method of a conductive polymer using plasma.

To be specific, in accordance with a first aspect of the present disclosure, there is provided a solid doping method of a conductive polymer using plasma, including the processes of: synthesizing dopant nanopowder as a solid dopant; treating the dopant nanopowder with plasma; and doping a conductive polymer by mixing the dopant nanopowder treated with the plasma and the conductive polymer dispersed in a solvent.

In accordance with a second aspect of the present disclosure, there is provided a solid doping method of a conductive polymer using plasma including: preparing a conductive polymer nanoparticle or an article such as a film or fiber containing a conductive polymer nanoparticle; and treating the conductive polymer nanoparticle or the article such as a film or fiber containing a conductive polymer nanoparticle with plasma.

In accordance with a third aspect of the present disclosure, there is provided a solid dopant for doping a conductive polymer including a dopant nanopowder which has acidity (pH) adjusted to about 4 or less by plasma treatment and is hydrophilic and dispersive in a solvent.

In accordance with an embodiment of the present invention, the process of treating the dopant nanopowder, the conductive polymer nanoparticle or the article containing a conductive polymer nanoparticle with plasma may include loading the dopant nanopowder, the conductive polymer nanoparticle or the article containing a conductive polymer nanoparticle into a vessel in a plasma chamber so as to be exposed to plasma; selecting a gas suitable for generating plasma and injecting the gas into the plasma chamber; applying voltage to the plasma chamber to generate plasma; controlling an exposure time of the conductive polymer nanoparticle or the article containing a conductive polymer nanoparticle to the generated plasma; turning off the generation of the plasma; and collecting the conductive polymer nanoparticle or the article containing a conductive polymer nanoparticle treated with the plasma.

In accordance with another embodiment of the present invention, pretreating the conductive polymer nanoparticle or the article containing a conductive polymer nanoparticle is further included prior to the treatment with the plasma as described above.

In accordance with still another embodiment of the present invention, the dopant nanopowder used for the plasma treatment may include lead and its salts, barium salts, and free metals such as zinc, tin, silver, tungsten, molybdenum, platinum and gold, salts or an alloy of these metals. In some embodiments, the dopant nanopowder used for the plasma treatment may be selected from a group consisting of titania, tungsten oxide, copper oxide, iron oxide, zinc oxide, tin oxide, zirconium oxide, vanadium oxide, nickel oxide, cadmium oxide, selenium oxide, barium titanate and a mixture thereof; or, selected from the group consisting of zinc sulfate, zinc iodide, barium iodide, sodium iodide, cesium iodide, lead iodide, zinc oxide, cesium bromide, barium bromide, ZnS, ZnCdS, Gd₂O₂S, Y₂O₂S, CaWO₃, ZnSiO₄, and a mixture thereof. In other embodiments, the dopant nanopowder used for the plasma treatment may include carbon nanotube, carbon black, carbon fiber, fullerene iodine or bromine.

Furthermore, in the present invention, nano particles or microparticles of the conductive polymer themselves may be plasma-treated, or a solid article such as a film or fiber containing nano particles or microparticles of the conductive polymer may be plasma-treated.

If the dopant nanopowder treated with plasma and the conductive polymer are mixed in a solvent, the solvent may be selected from a group consisting of distilled water, tetrachloroethane, trichloroethane, chloroform, bis(2-chloroethyl)ether, 1,2,3-trichloropropane, dichloromethane, ethylchloride, dichloroethyl ether, dichloropropane, neopenthyl alcohol, isopropyl alcohol, alkylbutanol, alkylpentanol, butanol, propanol, pentanol, 1,5-pentanediol, amyl alcohol, cyclopentanone, 4-methyl-2-pentanone, cyclohexanone, diacetone alcohol, isopropanol, 2-ethyl-1,3-hexanediol, ethyl hexanol, cyclohexanol, heptanol, octanol, decanol, dodecanol, propylene carbonate, dimethyl glutarate, benzyl Acetate, ethyl acetoaceate, ethylene glycol dimethyl ether, diethylene glycol diethyl ether, diethylene glycol dimethyl ether, diethylene glycol monoethyl ether, diethylene glycol monomethyl ether, ethylene glycol monobutyl ether, ethylene glycol monomethyl ether, dimethylformamide, N-methylpyrrolidine, decane, tetrahydrofuran, dichloroethane, nitrobenzene, and a mixture thereof, but it is not limited thereto.

The solvent may further include a dispersant selected from a group consisting of a surfactant, a water-soluble polymer, and a mixture thereof.

In accordance with still another embodiment of the present invention, an equivalent ratio of the conductive polymer to the dopant nanopowder treated with the plasma is from about 1:0.01 to about 1:10, but it is not limited thereto.

In accordance with still another embodiment of the present invention, the conductive polymer may be, for example, polyaniline, polypyrrole, polythiophene, poly phenylene-vinylene, polyphenysulfide, or poly para-phenylene but not limited thereto.

The process of doping the conductive polymer with the dopant nanopowder treated with the plasma may be performed by mixing the conductive polymer and the dopant nanopowder treated with the plasma in the solvent and by sonicating and stirring the mixture and homogenizing it with a homogenizer.

In accordance with still another embodiment of the present invention, the process of treating the dopant nanopowder with the plasma is carried out at a temperature ranging from about −10° C. to about 800° C., but it is not limited thereto.

In accordance with still another embodiment of the present invention, the plasma used in the process of treating the dopant nanopowder with the plasma is generated at a pressure ranging from about 10⁻⁶ Torr to about 5 atm, but it is not limited thereto.

In accordance with still another embodiment of the present invention, the plasma gas is selected from a group consisting of an inert gas including argon, helium, and N₂; H₂, O₂; a fluoride gas including CF₄, NF₃ and SF₆; a hydrocarbon gas including CH₄, C₂H₄, and C₂H₂; SO, SO₂, NO₂, NO, CO₂, CO, NH₃ gas; and a mixture thereof.

In accordance with still another embodiment of the present invention, the plasma gas is selected from a group consisting of H₂O₂ CH₃OH, C₂H₅OH, CH₃COCH₃, aniline, a C₆˜C₂₀ hydrocarbon liquid, HCl, HClO₄, HBF₄, HPF₆, phosphoric acids, dichloroacetic acid, an organic sulfonic acid, pyrubic acid, and a mixture thereof, which can be used by evaporation of a liquid state thereof.

In accordance with still another embodiment of the present invention, the plasma used in the process of treating the dopant nanopowder with the plasma is selected from a group consisting of radio frequency plasma, high-frequency plasma, dielectric barrier discharge plasma, AC or DC glow discharge plasma, middle frequency plasma, arc plasma, corona discharge plasma and a combination thereof.

In accordance with a fourth aspect of the present disclosure, there is provided an apparatus for preparing a solid dopant for doping a conductive polymer using plasma. The apparatus may include a plasma chamber having a gas inlet and a gas outlet at one side thereof; a vessel, into which solid dopant nanopowder to be treated with plasma is loaded, being placed in the plasma chamber; and a plasma generating device placed in the plasma chamber and configured to irradiate plasma to the vessel.

In accordance with an embodiment of the present invention, the plasma chamber has a vacuum device including a vacuum pump.

In accordance with another embodiment of the present invention, the apparatus for preparing a solid dopant for doping a conductive polymer using plasma may further include a vibration-applying device or ultrasound-applying device being configured to stir the solid dopant nanopowder loaded in the vessel for uniformly treating the solid dopant nanopowder with the plasma.

In accordance with still another embodiment of the present invention, the vessel has a stage being configured to adjust a distance between the plasma and the solid dopant nanopowder.

In accordance with a fifth aspect of the present disclosure, there is provided an apparatus for solid doping a conductive polymer using plasma. The apparatus includes a plasma chamber having a gas inlet and a gas outlet at one side thereof; a vessel, into which a conductive polymer nanoparticle to be treated with plasma or a solid articlecontaining a conductive polymer nanoparticle is loaded, being placed in the plasma chamber; and a plasma generating device placed in the plasma chamber and configured to irradiate plasma to the vessel.

In accordance with the present disclosure, it is possible to process a solid dopant nanoparticle as a conductive polymer, a conductive polymer nanoparticle or a solid article containing the conductive polymer nanoparticle so as to have high dispersibility in a solvent using various kinds of plasma without using chemicals such as a strong oxidant agent. Therefore, in accordance with the present disclosure, it is possible to prepare solid dopants having high dispersibility in a solvent and capable of doping a conductive polymer. Further, the present disclosure provides a method and an apparatus of preparing the solid dopant, a solid doping method of a conductive polymer using the solid dopant, and a solid doping method of a conductive polymer using a plasma treatment. In accordance with the present disclosure, it is possible to perform a solid doping of a conductive polymer using various kinds of plasma without using chemicals such as a strong oxidizing agent or it is possible to easily prepare nano-sized solid dopant for doping a conductive polymer and a conductive polymeric composite containing nanoparticles so as to have high dispersibility in a solvent using various kinds of plasma, and, thus, a conductive polymer can be applied in more fields.

### BRIEF DESCRIPTION OF THE DRAWINGS

The disclosure may best be understood by reference to the following description taken in conjunction with the following figures:

FIG. 1 is a flow chart showing a process of treating a dopant nanopowder using plasma in accordance with an example of the present invention;

FIG. 2 is a cross-sectional view of a surface treating apparatus capable of performing a surface treatment to a nanopowder using plasma in accordance with an example of the present invention;

FIG. 3 is a photograph showing changes in color of titanium dioxide treated with a plasma+EB (left), titanium dioxide not treated with a plasma+EB (middle) and EB only (right) in a NMP solvent;

FIG. 4 is a FTIR spectrum of titanium dioxide nanopowder depending on a plasma treatment time; and

FIG. 5 is a TGA spectrum of titanium dioxide nanopowder depending on a plasma treatment time.

### DETAILED DESCRIPTION OF THE INVENTION

Hereinafter, there will be described a method and an apparatus of preparing a solid dopant for a conductive polymer, a solid doping method of a conductive polymer using the solid dopant, and a doping method of conductive polymer nanoparticles or a solid article containing the conductive polymer nanoparticles using plasma in accordance with examples of the present invention will be described in detail with reference to the accompanying drawings.

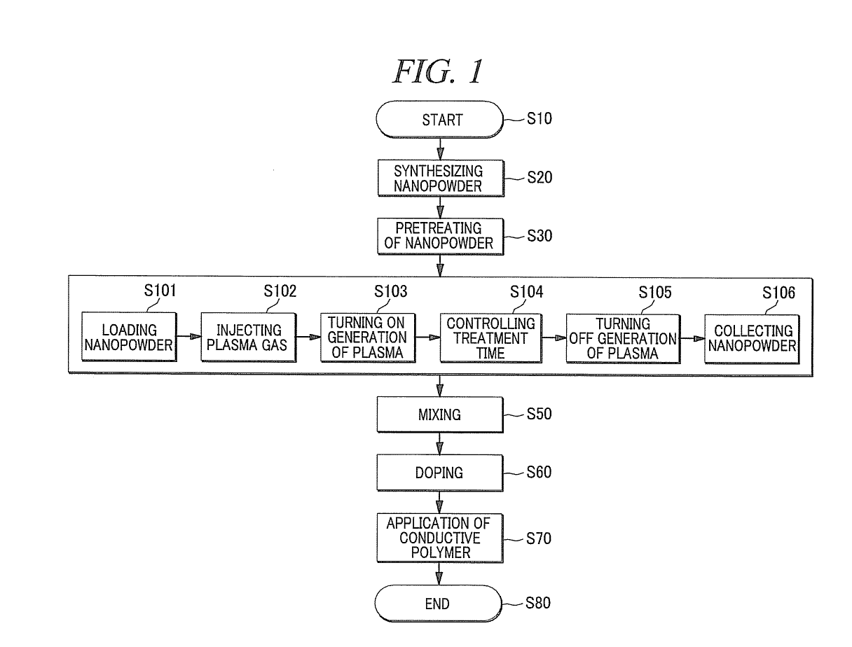

FIG. 1 shows a procedure of a treatment of dopant nanopowder using plasma in accordance with an example of the present invention and a doping method of a conductive polymer using the dopant nanopowder treated with the plasma.

FIG. 1 provides a flowchart showing a procedure from a step (step S20) of synthesizing nanopowder to a step (step S70) of applying to a conductive polymer containing the nanopowder.

First, solid dopant nanopowder is synthesized (step S20). The dopant nanopowder can be prepared by a conventional synthesizing method of nanopowder which has been known to those skilled in the art. It has been well known that arc-discharge, laser vaporization, vapor phase growth, thermal chemical vapor deposition, plasma chemical vapor deposition, gas condensation, flame synthesis, sol-gel processing, plasma sputtering, spray pyrolysis, and electrostatic spray deposition is a synthesizing method of nanopowder. Further, conductive polymer nanoparticles can be prepared in accordance with Korean Laid-open Publication No. 10-0648894.

Then, if necessary, the synthesized dopant nanopowder may be pretreated (step S30). For example, if the dopant nanopowder includes a carbon nanotube, transition metal contained in the carbon nanotube is removed by a physicochemical treatment during the synthesizing step and amorphous carbon is also removed during the same step. The physicochemical treatment includes a thermal treatment with oxidizing air at a temperature ranging from about 400° C. to about 800° C. or a treatment with an inorganic strong acid such as hydrochloric acid and sulfuric acid. Further, if the dopant nanoparticles are metallic oxides, the particles agglomerated during the synthesizing step can be segregated or separated from each other by ultrasonic waves or ball milling.

Subsequently, the pretreated dopant nanoparticles are modified (step S100). That is, a surface treatment using plasma is employed in the present invention in order to achieve a surface treatment effect (i.e., improvement of dispersibility in a solvent and formation of a functional group for doping a conductive polymer).

Generally, plasma can be classified into low pressure plasma and high pressure plasma according to a pressure generated. Generally, the low pressure plasma has various pressure levels depending on where to be applied. In case of the modification of the carbon nanotube in accordance with the example of the present invention, it is desirable to use plasma generated at a pressure ranging from about 10⁻⁶ Torr to about several hundreds Torr. The high pressure plasma may be plasma generated at a pressure ranging from about several hundreds Torr to about 5 atm. The low pressure plasma and the high pressure plasma may be, for example, radio frequency plasma, high-frequency plasma (0.3 GHz˜20 GHz), dielectric barrier discharge plasma, AC or DC glow discharge plasma, middle frequency plasma, arc plasma, and corona discharge plasma. For example, low pressure discharge plasma generally has a characteristic of glow discharge which can be found in fluorescent lights.

In the step (step S100) of modifying the dopant nanopowder, a chemical functional group which varies depending on an application method of plasma can be formed at a surface of the nanopowder. In this regard, there will be explained later.

After the step (step S100) of modifying the dopant nanopowder, the process proceeds to a step (step S50) of mixing, a step (step S60) of doping, and a step (step 70) of application of a conductive polymer.

In the step (step S50) of mixing the dopant nanopowder treated with the plasma and the conductive polymer in a solvent, the solvent may be selected from a group consisting of distilled water, tetrachloroethane, trichloroethane, chloroform, bis(2-chloroethyl)ether, 1,2,3-trichloropropane, dichloromethane, ethyl chloride dichloroethyl ether, dichloropropane, neopenthyl alcohol, isopropyl alcohol, alkylbutanol, alkylpentanol, butanol, propanol, pentanol, 1,5-pentanediol, amyl alcohol, cyclopentanone, 4-methyl-2-pentanone, cyclohexanone, diacetone alcohol, isopropanol, 2-ethyl-1,3-hexanediol, ethyl hexanol, cyclohexanol, heptanol, octanol, decanol, dodecanol, propylene carbonate, dimethyl glutarate, benzyl acetate, ethyl acetoaceate, ethylene glycol dimethyl ether, diethylene glycol diethyl ether, diethylene glycol dimethyl ether, diethylene glycol monoethyl ether, diethylene glycol monomethyl ether, ethylene glycol monobutyl ether, ethylene glycol monomethyl ether, dimethylformamide, N-methylpyrrolidine, decane, tetrahydrofuran, dichloroethane, nitrobenzene, and a mixture thereof, but it is not limited thereto.

Further, the solvent may further include a dispersant selected from a group consisting of a surfactant, a water-soluble polymer, and a mixture thereof.

It is desirable to set an equivalent ratio of the conductive polymer to the dopant nanopowder treated with the plasma in the range from about 1:0.01 to about 1:10.

The conductive polymer may be, for example, polyaniline, polypyrrole, polythiophene, poly phenylene-vinylene, poly phenylene sulfide, or poly para-phenylene.

The process (step S60) of doping the conductive polymer with the dopant nanopowder treated with the plasma may be performed by sonicating and stirring the mixture and homogenizing it with a homogenizer.

Hereinafter, the step (step S100) of modifying the dopant nanopowder will be described in detail. The step (step S100) of modifying the dopant nanopowder may include a step (step S101) of loading the dopant nanopowder into a vessel so as to be exposed to plasma, a step (step S102) selecting a plasma gas suitable for forming the chemical functional group at the surface of the dopant nanopowder and injecting the gas into the vessel, a step (step S103) of turning on generation of plasma, a step (step S104) of controlling an exposure time of the dopant nanopowder to the generated plasma, a step (step S105) of turning off the generation of the plasma, and a step (step S106) of collecting the dopant nanopowder treated with the plasma.

In the step (step S101) of loading the nanopowder, it is possible to delay or accelerate a chemical reaction between the nanopowder and the plasma by decreasing or increasing a temperature of the vessel into which the dopant nanopowder is loaded, and the temperature of the vessel can be controlled in the range from about −10° C. to about 800° C.

If the low pressure plasma is employed in the step (step S102) of injecting the plasma gas, the selected plasma gas is maintained and controlled at a pressure in the range from about 10⁻⁶ Torr to about several hundreds Torr.

In the step (step S102) of injecting the plasma gas, the plasma gas may be selected from a group consisting of an inert gas such as argon and helium, H₂, N₂, O₂, a fluoride gas such as CF₄, NF₃ and SF₆, a hydrocarbon gas such as CH₄, C₂H₄ and C₂H₂, SO, SO₂, NO₂, NO, CO₂, CO, NH₃ gas, and a mixture thereof. Further, the plasma gas may be selected from a group consisting of H₂O₂, CH₃OH, C₂H₆₀H, CH₃COCH₃, aniline, a C₆˜C₂₀ hydrocarbon liquid, HCl, HClO₄, HBF₄, HPFₛ, phosphoric acids, dichloroacetic acid, an organic sulfonic acid, pyrubic acid, and a mixture thereof, which can be used by evaporation of a liquid state thereof.

The step (step S100) can be repeated several times by adding dopant nanopowder or overturning the dopant nanopowder in order to uniformly treat the dopant nanopowder. Further, in the step (step S104), it is possible to uniformly modify the dopant nanopowder by controlling a processing time.

The procedure of the treatment using the plasma as shown in FIG. 1 can be applied to a treatment of the conductive polymer nanoparticle or a solid article containing the conductive polymer nanoparticle using plasma and a solid doping method of a conductive polymer in the same manner.

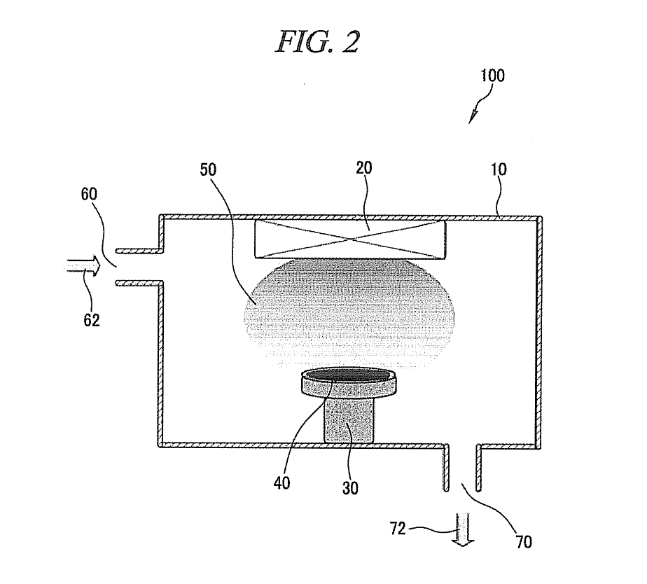

FIG. 2 shows an apparatus of preparing a solid dopant for doping a conductive polymer using plasma in accordance with an example of the present invention.

Referring to FIG. 2, an apparatus 100 for modification of the present invention includes a plasma chamber 10, a plasma generating device 20, and a dopant nanopowder vessel 30.

The plasma chamber 10 includes a gas inlet 60 for injecting a plasma gas 62 and a gas outlet 70 for discharging a reacted plasma gas 72. If low pressure plasma is employed in this case, a vacuum device including a vacuum pump (not illustrated) may be provided at one side of the plasma chamber 10.

In the apparatus 100 for modification, there may be provided a device, such as a vibration-applying device or ultrasound-applying device, configured to stir the solid dopant nanopowder 40 loaded in the dopant nanopowder vessel 30 for uniformly treating the solid dopant nanopowder with plasma 50. The nanopowder vessel 30 may be a batch type or an in-line type.

Further, a stage (not illustrated) can be provided in the dopant nanopowder vessel 30 in order to adjust a distance between the plasma 50 and the dopant nanopowder 40.

In order to change a physicochemical characteristic of the dopant nanopowder 40, the plasma gas may be selected from a group consisting of an inert gas such as argon and helium, H₂, N₂, O₂, a fluoride gas such as CF₄, NF₃ and SF₆, a hydrocarbon gas such as CH₄, C₂H₄, and C₂H₂, SO, SO₂, NO₂, NO, CO₂, CO, NH₃ gas, and a mixture thereof. Further, the plasma gas may be selected from a group consisting of H₂O₂ CH₃OH, C₂H₅OH, CH₃COCH₃, aniline, a C₆˜C₂₀ hydrocarbon liquid, HCl, HClO₄, HBF₄, HPF₆, phosphoric acids, dichloroacetic acid, an organic sulfonic acid, pyrubic acid, and a mixture thereof, which can be used by evaporation of a liquid state thereof.

Hereinafter, there will be described a procedure of a surface treatment of the dopant nanopowder in a plasma atmosphere using the plasma generating device 20.

First, the dopant nanopowder to be surface treated is loaded into the dopant nanopowder vessel 30 and the plasma generating device 20 is operated. If low pressure plasma is employed in this case, the inside of the plasma chamber 10 is adjusted to be in a low pressure state by operating the vacuum pump and the plasma gas 62 injected through the gas inlet 60 is converted into plasma by the plasma generating device 20. Formed at a surface of the generated plasma is a chemical functional group containing chemical active species (ions, electrons, radicals) based on a gas used for generating the plasma.

The apparatus of preparing the solid dopant for doping the conductive polymer using the plasma illustrated in FIG. 2 can be applied to a plasma-treating apparatus of the conductive polymer nanoparticle or the solid article containing the conductive polymer nanoparticle.

Hereinafter, the present invention will be explained in more detail with reference to several examples but it is not limited thereto.

### EXAMPLES

### Example 1

A titanium dioxide nanopowder (average particle size=25 nm) as a solid dopant for a conductive polymer was treated with a mixed gas including about 0.3 LPM (liter per minute) of 3% sulfur dioxide (SO₂) diluted by an argon gas and about 0.1 LPM of oxygen and DC plasma having a pressure of about 0.2 Torr, and about 10 mg of the treated titanium dioxide nanopowder was dispersed in about 10 ml of distilled water. In this case, acidity (pH) was in the range from about 1 to about 4 for a plasma treatment time of from about 3 minutes to about 10 minutes.

### Example 2

A conductive polymer-dopant solution including a mixture of about 95 mg of titanium dioxide nanopowder as a solid dopant for a conductive polymer, of which acidity was adjusted to about 3.2 pH by the plasma treatment as shown in Example 1, about 15 mg of a polyaniline conductive polymer base (EB), about 6 ml of N-methylpyrrolidine (NMP), and about 0.5 ml of distilled water was stirred. In this case, the conductive-polymer was doped by the solid dopant titanium dioxide nanopowder treated with the plasma and it was found that a color of the conductive-polymer dopant solution was changed from blue (typical color of a non-doped EB in a NMP solution) to green.

### Example 3

A titanium dioxide nanopowder (average particle size=25 nm) as a solid dopant for a conductive polymer was treated with a mixed gas including about 0.3 LPM (liter per minute) of 3 sulfur dioxide (SO₂) diluted by an argon gas, about 0.1 LPM of oxygen, and about 0.1 LPM of hydrogen and DC plasma having a pressure of about 0.25 Torr, and about 10 mg of the titanium dioxide nanopowder was dispersed in about 10 ml of distilled water. In this case, acidity (pH) was in the range from about 2.3 to about 4 for a plasma treatment time of from about 3 minutes to about 10 minutes.

### Example 4

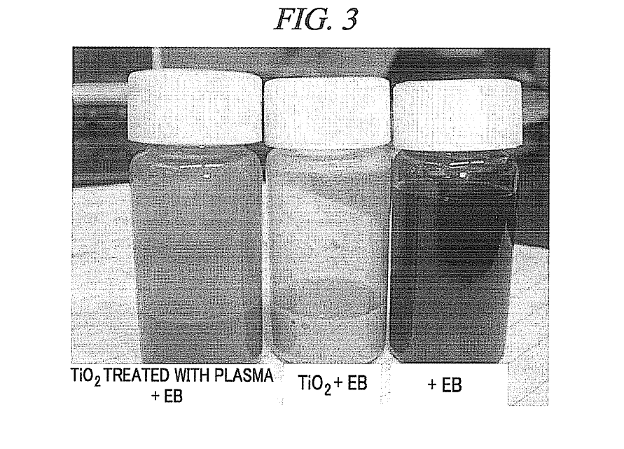

A conductive polymer-dopant solution obtained by mixing about 190 mg of titanium dioxide having acidity of about 3.5 as shown in Example 3 and about 38 mg of a polyaniline conductive polymer base (EB) with about 9 ml of N-methylpyrrolidine (NMP) was stirred. FIG. 3 shows a color change of the titanium dioxide after a plasma treatment+EB (left), a color change of the titanium dioxide before a plasma treatment+EB (middle) and a color of EB (right). It was found that a color of a solution containing the titanium dioxide treated with plasma+EB was changed from blue (middle or right) to green. It can be seen from such a color change that the conductive polymer base (EB) was doped by the titanium dioxide treated with plasma.

### Example 5

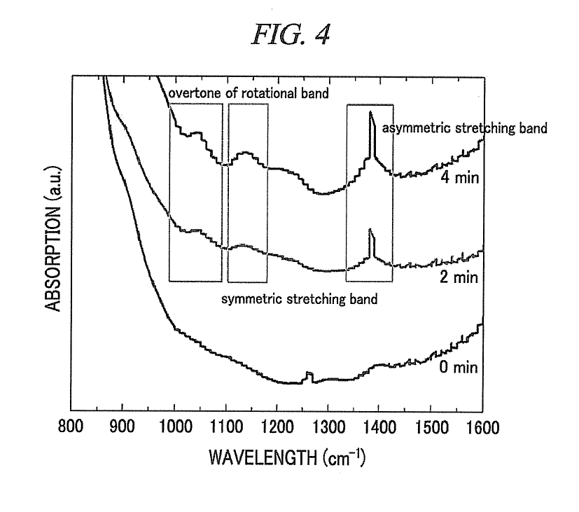

FIG. 4 is a FTIR spectrum of titanium dioxide nanopowder as a solid dopant depending on a plasma treatment time as shown in Example 1. The plasma treatment time was set to 0, about 2, and about 4 minutes. As can be seen from FIG. 4, it was found that as the treatment time was increased, peaks related SO₂ and SO₃ introduced to a surface of titanium dioxide nanopowder as s solid dopant became higher.

### Example 6

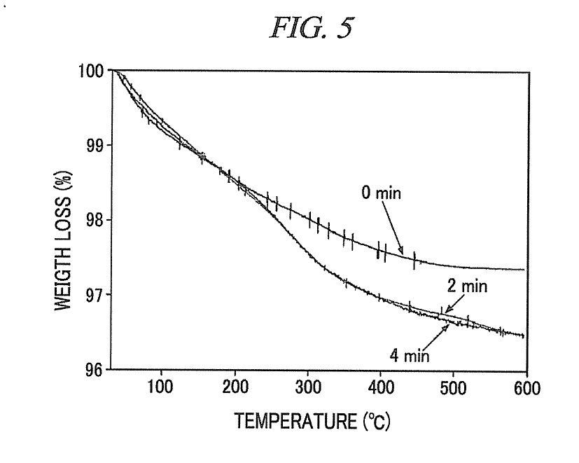

FIG. 5 is a TGA spectrum of titanium dioxide nanopowder as a solid dopant depending on a plasma treatment time as shown in Example 1. Referring to FIG. 5, an initial weight loss occurred at a temperature of about 100° C., which was caused by evaporation of water adsorbed onto the nanopowder. A second weight loss continuously occurred in a temperature range between about 200° C. and about 350° C. According to a thesis of Ye et al. (Journal of Membrane Science, vol. 279, pp. 570-577 (2006)), it was reported that the second weight loss was caused by pyrolysis of a sulfonic acid (SO₃H—) functional group. That is, the TGA spectrum of FIG. 5 shows that a conductive polymer base (EB) was doped by sulfonic acid formed on the surface of the nanopowder during the plasma treatment.

The above description of the present invention is provided for the purpose of illustration, and it would be understood by those skilled in the art that various changes and modifications may be made without changing technical conception and essential features of the present invention. Thus, it is clear that the above-described examples are illustrative in all aspects and do not limit the present invention.

What is claimed is:

1. A solid doping method of a conductive polymer using plasma, comprising the processes of:
synthesizing dopant nanopowder as a solid dopant;
treating the dopant nanopowder with plasma; and
doping a conductive polymer by mixing the dopant nanopowder treated with the plasma and the conductive polymer dispersed in a solvent,
wherein the dopant nanopowder includes a material selected from a group consisting of titania, tungsten oxide, copper oxide, iron oxide, zinc oxide, tin oxide, zirconium oxide, vanadium oxide, nickel oxide, cadmium oxide, selenium oxide, barium titanate, and a mixture thereof, or includes a material selected from a group consisting of zinc sulfate, zinc iodide, barium iodide, sodium iodide, cesium iodide, lead iodide, zinc oxide, cesium bromide, barium bromide, ZnS, ZnCdS, Gd₂O₂S, Y₂O₂S, CaWO₃, ZnSiO₄ and a mixture thereof.

2. The solid doping method of claim 1, wherein the process of treating the dopant nanopowder with plasma includes:
loading the dopant nanopowder into a vessel in a plasma chamber so as to be exposed to plasma;
selecting a gas suitable for generating plasma and injecting the gas into the plasma chamber;
applying voltage to the plasma chamber to generate plasma;
controlling an exposure time of the dopant nanopowder to the generated plasma;
turning off the generation of the plasma; and
collecting the dopant nanopowder treated with the plasma.

3. The solid doping method of claim 1, wherein acidity (pH) of the dopant nanopowder treated with the plasma is about 4 or less.

4. The solid doping method of claim 1, further comprising:
pretreating the dopant nanopowder prior to the process of treating the dopant nanopowder with the plasma.

5. The solid doping method of claim 1, wherein an equivalent ratio of the conductive polymer to the dopant nanopowder treated with the plasma is from about 1:0.01 to about 1:10.

6. The solid doping method of claim 1, wherein the process of treating the dopant nanopowder with the plasma is carried out at a temperature ranging from about −10° C. to about 800° C.

7. The solid doping method of claim 1, wherein the plasma used in the process of treating the dopant nanopowder with the plasma is generated at a pressure ranging from about 10⁻⁶ Torr to about 5 atm.

8. The solid doping method of claim 2, wherein the plasma gas is selected from a group consisting of an inert gas including argon, helium, and N₂; H₂, O₂; a fluoride gas including CF₄, NF₃ and SF₆; a hydrocarbon gas including CH₄, C₂H₄, and C₂H₂; SO, SO₂, NO₂, NO, CO₂, CO, NH₃ gas; and a mixture thereof.

9. The solid doping method of claim 2, wherein the plasma gas is selected from a group consisting of H₂O₂, CH₃OH, C₂H₅OH, CH₃COCH₃, aniline, a C₆˜C₂₀ hydrocarbon liquid, HCl, HClO₄, HBF₄, HPF₆, phosphoric acids, dichloroacetic acid, an organic sulfonic acid, pyrubic acid, and a mixture thereof, which is capable of being used by evaporation of a liquid state thereof.

10. The solid doping method of claim 1, wherein the dopant nanopowder is selected from a group consisting of titania, tungsten oxide, copper oxide, iron oxide, zinc oxide, tin oxide, zirconium oxide, vanadium oxide, nickel oxide, cadmium oxide, selenium oxide, barium titanate, and a mixture thereof.

11. The solid doping method of claim 1, wherein the dopant nanopowder is selected from a group consisting of zinc sulfate, zinc iodide, barium iodide, sodium iodide, cesium iodide, lead iodide, zinc oxide, cesium bromide, barium bromide, ZnS, ZnCdS, Gd₂O₂S, Y₂O₂S, CaWO₃, ZnSiO₄, and a mixture thereof.

12. The solid doping method of claim 1, wherein the plasma used in the process of treating the dopant nanopowder with the plasma is selected from a group consisting of radio frequency plasma, high-frequency plasma, dielectric barrier discharge plasma, AC or DC glow discharge plasma, middle frequency plasma, arc plasma, corona discharge plasma, and a combination thereof.

13. The solid doping method of claim 1, wherein the dopant nanopowder treated with the plasma is hydrophilic and dispersive in the solvent.

14. The solid doping method of claim 1, wherein the conductive polymer includes polyaniline, polypyrrole, polythiophene, polyphenylenevinylene, polyphenylsulfide or polyparaphenylene.

15. A solid dopant for doping a conductive polymer, the solid dopant comprising:
dopant nanopowder selected from a group consisting of titania, tungsten oxide, copper oxide, iron oxide, zinc oxide, tin oxide, zirconium oxide, vanadium oxide, nickel oxide, cadmium oxide, selenium oxide, barium titanate and a mixture thereof, or, selected from the group consisting of zinc sulfate, zinc iodide, barium iodide, sodium iodide, cesium iodide, lead iodide, zinc oxide, cesium bromide, barium bromide, ZnS, ZnCdS, Gd₂O₂S, Y₂O₂S, CaWO₃, ZnSiO₄, and a mixture thereof,
wherein the solid dopant has acidity (pH) adjusted to about 4 or less by plasma treatment and is hydrophilic and dispersive in a solvent.

16. The solid dopant of claim 15, wherein the dopant nanopowder is selected from a group consisting of titania, tungsten oxide, copper oxide, iron oxide, zinc oxide, tin oxide, zirconium oxide, vanadium oxide, nickel oxide, cadmium oxide, selenium oxide, barium titanate, and a mixture thereof.

17. The solid dopant of claim 15, wherein the dopant nanopowder is selected from a group consisting of zinc sulfate, zinc iodide, barium iodide, sodium iodide, cesium iodide, lead iodide, zinc oxide, cesium bromide, barium bromide, ZnS, ZnCdS, Gd₂O₂S, Y₂O₂S, CaWO₃, ZnSiO₄, and a mixture thereof.

18. An apparatus for preparing a solid dopant for doping a conductive polymer using plasma, the apparatus comprising:
a plasma chamber having a gas inlet and a gas outlet at one side thereof;
a vessel, into which solid dopant nanopowder to be treated with plasma is loaded, placed in the plasma chamber;
a plasma generating device placed in the plasma chamber and configured to irradiate plasma to the vessel; and
a vibration-applying device or ultrasound-applying device configured to stir the solid dopant nanopowder loaded in the vessel for uniformly treating the solid dopant nanopowder with the plasma,
wherein the dopant nanopowder includes a material selected from a group consisting of titania, tungsten oxide, copper oxide, iron oxide, zinc oxide, tin oxide, zirconium oxide, vanadium oxide, nickel oxide, cadmium oxide, selenium oxide, barium titanate, and a mixture thereof, or includes a material selected from a group consisting of zinc sulfate, zinc iodide, barium iodide, sodium iodide, cesium iodide, lead iodide, zinc oxide, cesium bromide, barium bromide, ZnS, ZnCdS, Gd₂O₂S, Y₂O₂S, CaWO₃, ZnSiO₄, and a mixture thereof.

19. The apparatus of claim 18, wherein the plasma chamber has a vacuum device including a vacuum pump.

20. The apparatus of claim 18, wherein the vessel has a stage configured to adjust a distance between the plasma and the solid dopant nanopowder.
